(19) United States
(12) Patent Application Publication
(10) Pub. No.: US 2024/0413505 A1
(43) Pub. Date: Dec. 12, 2024

(54) BATTERY

(71) Applicant: TOYOTA JIDOSHA KABUSHIKI KAISHA, Toyota-shi (JP)

(72) Inventors: Takeru Hara, Toyota-shi (JP); Takuya Murata, Kariya-shi (JP)

(73) Assignee: TOYOTA JIDOSHA KABUSHIKI KAISHA, Toyota-shi (JP)

(21) Appl. No.: 18/732,943

(22) Filed: Jun. 4, 2024

(30) Foreign Application Priority Data
Jun. 7, 2023 (JP) 2023-094425

(51) Int. Cl. H01M 50/627; H01M 4/13; H01M 10/0525; H01M 10/0585; H01M 10/42; H01M 50/103

(52) U.S. Cl. CPC H01M 50/627; H01M 4/13; H01M 10/0525; H01M 10/0585; H01M 10/4235; H01M 50/103

(57) ABSTRACT

A battery includes: an electrode stack including a stack of electrodes, each including a current collector and an active material layer divided with channels in between; a sealing body that forms internal spaces holding electrolyte solution between current collectors and seals the internal spaces; and injection ports formed in sealing body and communicate internal spaces to the outside, wherein the internal spaces are formed by channels and uncoated regions around active material layers where active material layers are not provided, internal regions sealed by sealing body have polygonal shape when viewed from stacking direction of the electrode stack, the channels extend between divided regions of the active material layers from the side where the injection ports are in the opposite direction thereof, and cross-sectional area of regions of the uncoated regions that face surfaces where the injection ports are formed is larger than a cross-sectional area of the channels.

### CROSS-REFERENCE TO RELATED APPLICATION

This application is based on and claims priority under 35 USC 119 from Japanese Patent Application No. 2023-094425 filed on Jun. 7, 2023, the disclosure of which is incorporated by reference herein.

### BACKGROUND

### Technical Field

The present disclosure relates to a battery.

### Related Art

As a conventional battery manufacturing method, a manufacturing method is known which includes the step of injecting an electrolyte solution into a space between electrodes that are disposed opposing each other across a separator (e.g., Japanese Patent Application Laid-open (JP-A) No. 2013-191450).

Furthermore, JP-A No. 2022-188536 discloses a method of manufacturing a bipolar electricity storage device including: a first pressure reduction step of reducing the pressure of an internal space of a battery to a first pressure when causing an electrolyte solution to permeate the internal space; a first injection step of injecting, through an injection port from a retention unit retaining a predetermined amount of the electrolyte solution set in advance, the predetermined amount of the electrolyte solution into the internal space whose pressure was reduced in the first pressure reduction step; a second pressure reduction step of reducing to a second pressure the pressure of the internal space to which the predetermined amount of the electrolyte solution was injected through the retention unit and the injection port to thereby cause some of the electrolyte solution to flow back from the internal space to the retention unit; and a second injection step of raising, to a pressure higher than the second pressure, the pressure inside the retention unit retaining the electrolyte solution that has flowed back and injecting the electrolyte solution from the retention unit through the injection port into the internal space, wherein the second pressure reduction step includes an initial pressure reduction step of reducing the pressure of the internal space at a lower pressure reduction speed lower than that in the first pressure reduction step.

### SUMMARY

In this connection, in conventional batteries, reducing the volume (width) of uncoated regions where active material layers are not formed on current collectors had been considered from the standpoint of improving the battery capacity. However, there has been the problem that if the width of the uncoated regions is reduced too much, the flowability of the electrolyte solution in channels provided in the active material layers deteriorates.

The present disclosure has been made in view of the above circumstances, and it is an object thereof to provide a battery in which the ability of the electrolyte solution to be impregnated into the active material layers is improved.

Means for solving the above problem include the following aspects.

A battery of a first aspect of the present disclosure, including:
an electrode stack comprising a stack of electrodes, each including a current collector and an active material layer that is provided on one or both surfaces of the current collector and divided into plural regions with channels in between;
a sealing body that forms internal spaces holding an electrolyte solution between the current collectors that are adjacent and seals the internal spaces; and
injection ports that are formed in the sealing body and communicate the internal spaces with the outside,
wherein
the internal spaces are formed by the channels and uncoated regions around the active material layers where the active material layers are not provided,
internal regions sealed by the sealing body have a polygonal shape when viewed from a stacking direction of the electrode stack, and
when surfaces, on the internal space side, of the side of the sealing body where the injection ports are formed are called injection port-side surfaces,
the channels extend between the divided regions of the active material layers from the side where the injection port-side surfaces are in the opposite direction of the injection port-side surfaces, and
a cross-sectional area [a], in a cross-section orthogonal to the direction in which the injection port-side surfaces extend, of regions of the uncoated regions that face the injection port-side surfaces is larger than a cross-sectional area [d] of the channels in a cross-section orthogonal to the direction in which the channels extend.

The battery of a second aspect according to the present disclosure is the battery of the first aspect, wherein
the internal regions sealed by the sealing body have a quadrilateral shape when viewed from the stacking direction of the electrode stack, and
the battery has the injection ports only in a region of the sealing body that faces one side of the quadrilateral shape.

The battery of a third aspect according to the present disclosure is the battery of the first aspect or the second aspect, wherein the ratio ([d]/[a]) of the cross-sectional area [d] of the channels to the cross-sectional area [a] of the uncoated regions is 0.1 to 0.9.

The battery of a fourth aspect according to the present disclosure is the battery of any one of the first aspect to the third aspect, wherein the cross-sectional area [d] of the channels is 0.4 mm2 to 2.0 mm2.

The battery of a fifth aspect according to the present disclosure is the battery of any one of the first aspect to the fourth aspect, wherein the area of the electrode stack when viewed from the stacking direction of the electrode stack is 0.5 m² or more.

According to the present disclosure, there is provided a battery in which the ability of the electrolyte solution to be impregnated into the active material layers is improved.

### BRIEF DESCRIPTION OF THE DRAWINGS

FIG. 1 is a schematic cross-sectional view showing the configuration of a bipolar electricity storage device pertaining to an embodiment;

FIG. 2 is a schematic cross-sectional view showing the internal configuration of an electricity storage module shown in FIG. 1; and

FIG. 3 is a cross-sectional view orthogonal to a stacking direction of the electricity storage module shown in FIG. 2.

### DETAILED DESCRIPTION

A battery pertaining to an embodiment of the present disclosure will be described below with reference to the drawings. In the description of the drawings, identical reference signs are used for identical or similar elements, and redundant description will be omitted.

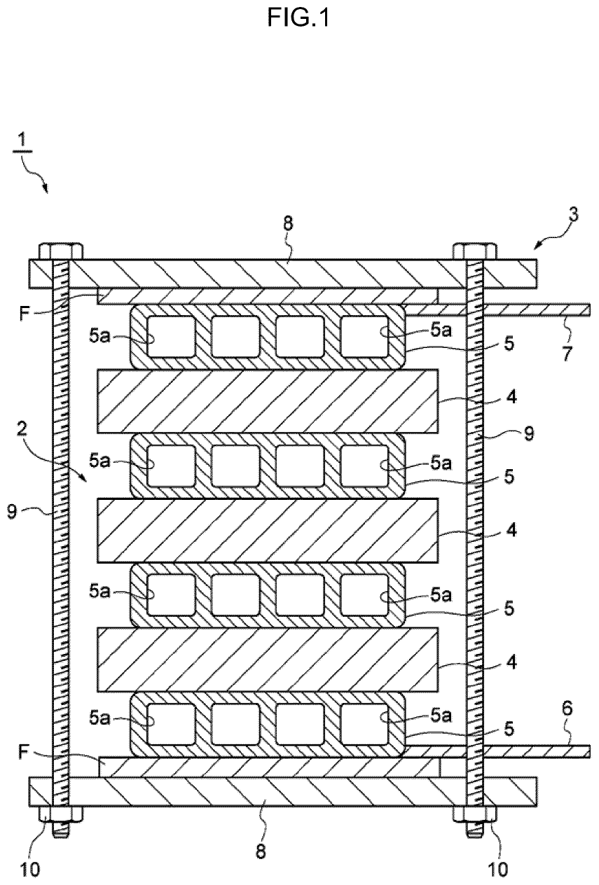

FIG. 1 is a schematic cross-sectional view showing the configuration of a bipolar electricity storage device pertaining to an embodiment. A bipolar electricity storage device 1 (hereinafter also simply called “the electricity storage device 1”) shown in FIG. 1 is a device used for batteries of various types of vehicles such as, for example, forklifts, hybrid electric vehicles, and battery electric vehicles. The electricity storage device 1 is a secondary battery such as, for example, a nickel-hydrogen secondary battery or a lithium-ion secondary battery.

In the present embodiment, a case where the electricity storage device 1 is a lithium-ion secondary battery will be exemplified. The electricity storage device 1 includes a module stack 2 and a restraining member 3 that applies a restraining load to the module stack 2 in a stacking direction of the module stack 2.

The module stack 2 includes electricity storage modules 4 and conductive plates 5 stacked and arranged on the electricity storage modules 4. The module stack 2 includes a plurality (here, three) of the electricity storage modules 4 and a plurality (here, four) of the conductive plates 5. The electricity storage modules 4 are bipolar batteries and have a rectangular shape as viewed from the stacking direction.

The electricity storage modules 4 that are adjacent to each other in the stacking direction are electrically interconnected via the conductive plates 5. The conductive plates 5 are disposed between the electricity storage modules 4 that are adjacent to each other in the stacking direction and on the outer sides of the electricity storage modules 4 positioned on the stack ends. A positive electrode terminal 6 is connected to one of the conductive plates 5 disposed on the outer sides of the electricity storage modules 4 positioned on the stack ends. A negative electrode terminal 7 is connected to the other of the conductive plates 5 disposed on the outer sides of the electricity storage modules 4 positioned on the stack ends. The positive electrode terminal 6 and the negative electrode terminal 7 are, for example, led out in a direction intersecting the stacking direction from edge portions of the conductive plates 5. Charging and discharging of the electricity storage device 1 are implemented by the positive electrode terminal 6 and the negative electrode terminal 7.

Inside the conductive plates 5, plural flow paths 5a for circulating a coolant such as air are provided. The flow paths 5a extend, for example, along a direction intersecting (orthogonal to) the stacking direction and the lead-out direction of the positive electrode terminal 6 and the negative electrode terminal 7. The conductive plates 5 have both a function as connection members that electrically interconnect the electricity storage modules 4 and a function as heat sinks that dissipate heat generated by the electricity storage modules 4 by circulating the coolant through the flow paths 5a.

The restraining member 3 is configured by a pair of end plates 8 that sandwich the module stack 2 in the stacking direction and fastening bolts 9 and nuts 10 that fasten together the end plates 8. Films F having an electrical insulation property are provided on surfaces of the end plates 8 on the module stack 2 side, and the end plates 8 and the conductive plates 5 are insulated from each other by the films F.

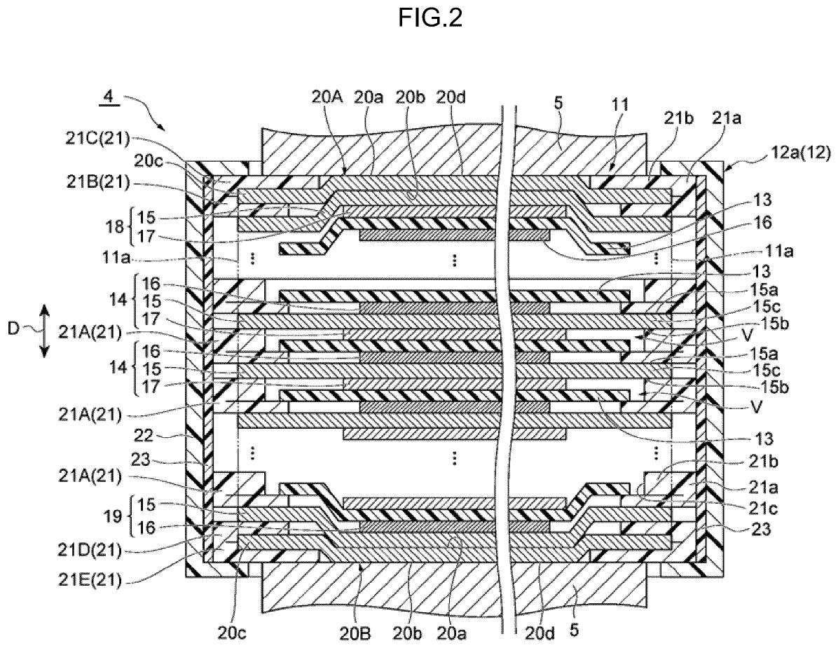

Next, the configuration of the electricity storage modules 4 will be described in detail. FIG. 2 is a schematic cross-sectional view showing the internal configuration of an electricity storage module shown in FIG. 1. As shown in FIG. 2, the electricity storage module 4 includes an electrode stack 11 and a sealing body 12 made of resin that seals the electrode stack 11. The electricity storage module 4 is, for example, formed in the shape of a rectangular cuboid.

The electrode stack 11 includes plural electrodes, which are stacked along a stacking direction D via separators 13, and current collectors (metal plates 20A, 20B), which are positioned on stack ends of the electrode stack 11. The plural electrodes include a negative terminal electrode 18, a positive terminal electrode 19, and plural bipolar electrodes 14 stacked between the negative terminal electrode 18 and the positive terminal electrode 19. The stack of the plural bipolar electrodes 14 is provided between the negative terminal electrode 18 and the positive terminal electrode 19.

The bipolar electrodes 14 each have a metal plate 15 that serves as a current collector and includes one surface 15a and another surface 15b provided on the opposite side of the one surface 15a, a positive electrode 16 that is provided on the one surface 15a, and a negative electrode 17 that is provided on the other surface 15b. The one surface 15a is a surface that faces one side in the stacking direction D and, for example, faces upward in the direction of gravity. The other surface 15b is a surface that faces the other side in the stacking direction D and, for example, faces downward in the direction of gravity. The positive electrode 16 is a positive electrode active material layer formed by coating the metal plate 15 with a positive electrode active material. The negative electrode 17 is a negative electrode active material layer formed by coating the metal plate 15 with a negative electrode active material. The positive electrode 16 of one bipolar electrode 14 in the electrode stack 11 opposes the negative electrode 17 of another bipolar electrode 14 that is adjacent to it on the one side in the stacking direction D across a separator 13. The negative electrode 17 of one bipolar electrode 14 in the electrode stack 11 opposes the positive electrode 16 of another bipolar electrode 14 that is adjacent to it on the other side in the stacking direction D across a separator 13.

The negative terminal electrode 18 has a metal plate 15 and a negative electrode 17 provided on the other surface 15b of the metal plate 15. The negative terminal electrode 18 is disposed on one end side in the stacking direction D so that the other surface 15b faces the central side of the electrode stack 11 in the stacking direction D. A metal plate 20A is further stacked on the one surface 15a of the metal plate 15 of the negative terminal electrode 18, and the negative terminal electrode 18 is electrically connected via the metal plate 20A to one of the conductive plates 15 that are adjacent to the electricity storage module 4. The negative electrode 17 provided on the other surface 15b of the metal plate 15 of the negative terminal electrode 18 opposes the positive electrode 16 of the bipolar electrode 14 on the one end in the stacking direction D via a separator 13.

The positive terminal electrode 19 has a metal plate 15 and a positive electrode 16 provided on the one surface 15a of the metal plate 15. The positive terminal electrode 19 is disposed on the other end side in the stacking direction D so that the one surface 15a faces the central side of the electrode stack 11 in the stacking direction D. A metal plate 20B is further stacked on the other surface 15b of the metal plate 15 of the positive terminal electrode 19, and the positive terminal electrode 19 is electrically connected via the metal plate 20B to the other of the conductive plates 5 that are adjacent to the electricity storage module 4. The positive electrode 16 provided on the one surface 15a of the metal plate 15 of the positive terminal electrode 19 opposes the negative electrode 17 of the bipolar electrode 14 on the other end in the stacking direction D via a separator 13.

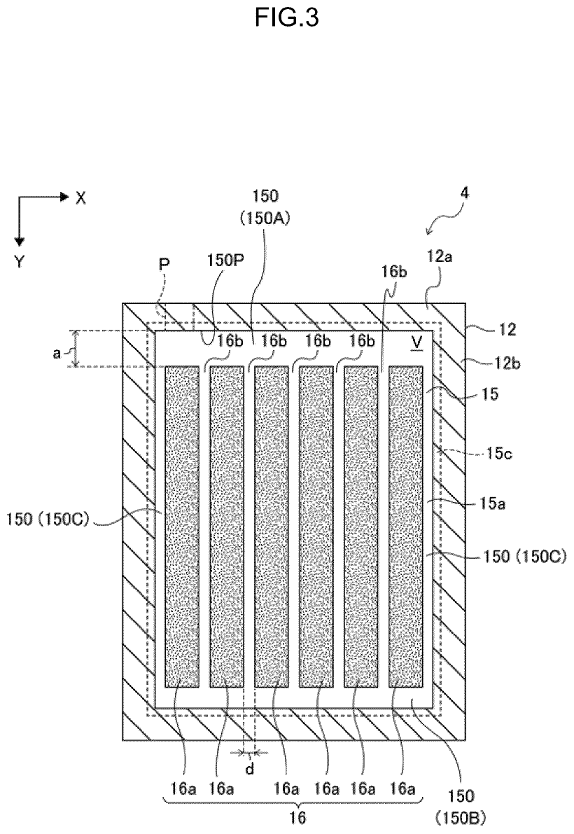

The metal plates 15 comprise a metal such as, for example, Al, SUS, Ni, or Cu. Each of the metal plates 15 is one of the metal plates included in the electrode stack 11. Edge portions 15c of the metal plates 15 form parts of uncoated regions 150 (see FIG. 3) that have rectangular frame shapes and are uncoated with the positive electrode active material and the negative electrode active material. Examples of the positive electrode active material configuring the positive electrodes 16 include oxide active materials. Examples of oxide active materials include rock salt layered active materials such as LiCoO₂, LiMnO₂, LiNiO₂, LiVO₂, LiNi_{1/3}Co_{1/3}Mn_{1/3}O₂, spinel active materials such as LiMn₂O₄ and Li(Ni_{0.5}Mn_{1.5})O₄, and olivine active materials such as LiFePO₄, LiMnPO₄, LiNiPO₄, and LiCuPO₄. Examples of the negative electrode active material configuring the negative electrodes 17 include carbon active materials, oxide active materials, and metal active materials. In the present embodiment, the regions where the negative electrodes 17 are formed on the other surfaces 15b of the metal plates 15 are larger in size than the regions where the positive electrodes 16 are formed on the one surfaces 15a of the metal plates 15. The electrode stack 11 has a plurality of metal plates 15, 20A, 20B that are stacked.

The separators 13 are members for preventing short-circuiting between the metal plates 15 and, for example, are formed as sheets. Examples of the separators 13 include porous films comprising polyolefin resins such as polyethylene (PE) and polypropylene (PP) and woven or nonwoven fabrics comprising polypropylene or methylcellulose. The separators 13 may be reinforced by a polyvinylidene fluoride resin compound. It will be noted that the separators 13 are not limited to sheets, and pocket separators may also be used.

The metal plates 20A, 20B are members that are substantially identical to the metal plates 15 and comprise a metal such as, for example, Al, SUS, Ni, or Cu. The metal plates 20A, 20B are each one of the metal plates included in the electrode stack 11. The metal plates 20A, 20B form uncoated electrodes where one surface 20a and another surface 20b thereof are not coated with either a positive electrode active material layer or a negative electrode active material layer. That is, the metal plates 20A, 20B are uncoated electrodes that do not have an active material layer on either surface.

Due to the metal plate 20A, the negative terminal electrode 18 is disposed between the metal plate 20A and the bipolar electrodes 14 along the stacking direction D. The other surface 20b of the metal plate 20A and the one surface 15a of the metal plate 15 of the negative terminal electrode 18 are electrically connected by virtue of being in direct contact without anything in between. Due to the metal plate 20B, the positive terminal electrode 19 is disposed between the metal plate 20B and the bipolar electrodes 14 along the stacking direction D. The one surface 20a of the metal plate 20B and the other surface 15b of the metal plate 15 of the positive terminal electrode 19 are electrically connected by virtue of being in direct contact without anything in between.

In the electrode stack 11, the central region of the electrode stack 11 (the region where the active material layers are disposed in the bipolar electrodes 14, the negative terminal electrode 18, and the positive terminal electrode 19) bulges in the stacking direction D compared with the surrounding region. For this reason, the metal plates 20A, 20B are bent in directions in which the central regions of the metal plates 20A, 20B have more distance between each other. The central regions of the one surface 20a of the metal plate 20A and the other surface 20b of the metal plate 20B contact the conductive plates 5.

The sealing body 12 is, for example, formed of an insulating resin in the shape of a rectangular tube overall. The sealing body 12 is, for example, formed in the shape of a rectangular tube having a pair of short side portions 12a and a pair of long side portions 12b (see FIG. 3). The sealing body 12 is provided so as to surround side surfaces 11a of the electrode stack 11. The sealing body 12 retains the edge portions 15c at the side surfaces 11a.

The sealing body 12 has plural first sealing portions 21 (resin portions), which are frame-like and provided on the edge portions of the metal plates (i.e., the edge portions 15c of the metal plates 15 and edge portions 20c of the metal plates 20A, 20B) included in the electrode stack 11, and a second sealing portion 22, which surrounds the first sealing portions 21 from outside along the side surfaces 11a and is bonded to each of the first sealing portions 21. The first sealing portions 21 and the second sealing portion 22 are, for example, an insulating resin, and examples of constituent materials of the resin include polypropylene (PP), polyphenylene sulfide (PPS), and modified polyphenylene ether (modified PPE).

The first sealing portions 21 are provided continuously around the entireties of the peripheries of the edge portions 15c of the metal plates 15 and the edge portions 20c of the metal plates 20A, 20B and have rectangular frame-like shapes as viewed from the stacking direction D. The first sealing portions 21 and the metal plates 15, and the first sealing portions 21 and the metal plates 20A, 20B, are airtightly joined together. The first sealing portions 21 extend outward beyond the edge portions 15c of the metal plates 15 or the edge portions 20c of the metal plates 20A, 20B as viewed from the stacking direction D. The first sealing portions 21 have outer portions 21a that jut out past the edges of the metal plates 15 or the metal plates 20A, 20B and inner portions 21b that are positioned inward of the edges of the metal plates 15 or the metal plates 20A, 20B. A welding layer 23 is formed on distal end portions (outer edge portions) of the outer portions 21a of the first sealing portions 21.

The plural first sealing portions 21 include plural first sealing portions 21A provided on the bipolar electrodes 14 and the positive terminal electrode 19, a first sealing portion 21B provided on the negative terminal electrode 18, a first sealing portion 21C provided on the metal plate 20A, and first sealing portions 21D, 21E provided on the metal plate 20B.

The first sealing portions 21A are joined to the one surfaces 15a of the metal plates 15 of the bipolar electrodes 14 and the positive terminal electrode 19. The inner portions 21b of the first sealing portions 21A are positioned between the edge portions 15c of the metal plates 15 that are adjacent to each other in the stacking direction D. The regions where the edge portions 15c of the one surfaces 15a of the metal plates 15 and the first sealing portions 21A coincide are regions where the metal plates 15 and the first sealing portions 21A are bonded.

In the present embodiment, the first sealing portions 21A are each formed in a two-layer structure by folding a single film in two. The outer edge portions of the first sealing portions 21A that are embedded in the second sealing portion 22 are folded-back portions (bent portions) of the film. The first layers of the films configuring the first sealing portions 21A are joined to the one surfaces 15a. The inner edges of the second layers of the films are positioned outward of the inner edges of the first layers of the films to form step portions on which the separators 13 are placed. The inner edges of the second layers of the films are positioned inward of the edges of the metal plates 15.

The first sealing portion 21B is joined to the one surface 15a of the metal plate 15 of the negative terminal electrode 18. The inner portion 21b of the first sealing portion 21B is positioned between the edge portion 15c of the metal plate 15 of the negative terminal electrode 18 and the edge portion 20c of the metal plate 20A that are adjacent to each other in the stacking direction D. The region where the edge portion 15c of the one surface 15a of the metal plate 15 and the inner portion 21b of the first sealing portion 21B coincide is a region where the metal plate 15 and the first sealing portion 21B are bonded. The first sealing portion 21B is also joined to the other surface 20b of the metal plate 20A. The region where the edge portion 20c of the other surface 20b of the metal plate 20A and the first sealing portion 21B coincide is a region where the metal plate 20A and the first sealing portion 21B are bonded. In the present embodiment, the first sealing portion 21B is also joined to the edge portion 20c of the other surface 20b of the metal plate 20A.

The first sealing portion 21C is joined to the one surface 20a (outer surface) of the metal plate 20A. The region where the edge portion 20c of the one surface 20a of the metal plate 20A and the first sealing portion 21C coincide is a region where the metal plate 20A and the first sealing portion 21C are bonded. The one surface 20a of the metal plate 20A has an exposed surface 20d that is exposed from the first sealing portion 21C. A conductive plate 5 is disposed in contact with the exposed surface 20d.

In the present embodiment, the outer edge portions of the first sealing portions 21B, 21C that are embedded in the second sealing portion 22 are continuous with each other. That is, the first sealing portions 21B, 21C are formed by folding a single film in two so as to sandwich the edge portion 20c of the metal plate 20A. The outer edge portions of the first sealing portions 21B, 21C are a folded-back portion of the film. The film configuring the first sealing portions 21B, 21C is joined to the edge portion 20c at both the one surface 20a and the other surface 20b of the metal plate 20A.

The first sealing portion 21D is joined to the one surface 20a of the metal plate 20B. The inner portion 21b of the first sealing portion 21D is positioned between the edge portion 15c of the metal plate 15 of the positive terminal electrode 19 and the edge portion 20c of the metal plate 20B that are adjacent to each other in the stacking direction D. The region where the edge portion 20c of the one surface 20a of the metal plate 20B and the first sealing portion 21D coincide is a region where the metal plate 20B and the first sealing portion 21D are bonded.

The first sealing portion 21E is disposed on the edge portion 20c of the other surface 20b (outer surface) of the metal plate 20B. In the present embodiment, the first sealing portion 21E is not joined to the metal plate 20B. The other surface 20b of the metal plate 20B has an exposed surface 20d that is exposed from the first sealing portion 21E. A conductive plate 5 is disposed in contact with the exposed surface 20d.

In the present embodiment, the outer edge portions of the first sealing portions 21D, 21E that are embedded in the second sealing portion 22 are continuous with each other. That is, the first sealing portions 21D, 21E are formed by folding a single film in two so as to sandwich the edge portion 20c of the metal plate 20B. The outer edge portions of the first sealing portions 21D, 21E are a folded-back portion of the film. The film configuring the first sealing portions 21D, 21E is joined to the edge portion 20c at the one surface 20a of the metal plate 20B.

Inside the electrode stack 11, plural internal spaces V are provided. Each of the internal spaces V is provided between metal plates that are adjacent. The internal spaces V are spaces that are airtightly and liquid-tightly partitioned by the metal plates and the sealing body 12 between metal plates that are adjacent in the stacking direction D. The internal spaces V hold an electrolyte solution (not shown in the drawings). The electrolyte solution includes, for example, a non-aqueous solvent and a support salt. Examples of non-aqueous solvents can include organic solvents such as carbonates, ethers, esters, nitriles, sulfones, and lactones. Examples of support salts can include lithium salts such as LiPF₆. The electrolyte solution is impregnated inside the separators 13, the positive electrodes 16, and the negative electrodes 17.

FIG. 3 is a cross-sectional view orthogonal to the stacking direction of the electricity storage module shown in FIG. 2. As shown in FIG. 3, injection ports P are provided in one of the short side portions 12a of the sealing body 12. The injection ports P penetrate the sealing body 12 in the lengthwise direction of the sealing body 12. The injection ports P communicate the internal spaces V with the outside space. The positions where the injection ports P are provided in the one short side portion 12a of the sealing body 12 differ depending on the positions of the corresponding internal spaces V in the stacking direction D (see FIG. 2). The injection ports P are staggered in the widthwise direction of the sealing body 12 so that injection ports P that are adjacent to each other in the stacking direction D (see FIG. 2) do not coincide. In the example in FIG. 3, an injection port P is provided in one end portion of the one short side portion 12a of the sealing body 12.

The shape of the internal region sealed by the sealing body 12 when viewed from the stacking direction (i.e., the shape of the interface between each internal space V and the sealing body 12 shown in FIG. 3) is rectangular. It will be noted that the shape of the internal region sealed by the sealing body 12 is not limited to being rectangular and may be quadrilateral or a polygonal shape other than quadrilateral. Furthermore, the corners of the polygonal shape may be rounded.

In FIG. 3, in the internal region (the rectangular region) sealed by the sealing body 12, the injection port P is formed only in a region of the sealing body 12 that faces one side of the rectangle. However, the injection port P may be provided in plural places; for example, the internal region sealed by the sealing body 12 may have a polygonal shape, and a total of two or more injection ports P may be formed in regions of the sealing body 12 that face two or more sides of the polygonal shape.

Each of the positive electrodes 16 includes plural divided regions 16a divided by channels 16b on the one surfaces 15a of the metal plates 15. When surfaces, on the internal space V side, of the side of the sealing body 12 where the injection ports P are formed are called injection port-side surfaces 150P, the channels 16b extend from the side where the injection port-side surfaces 150P are in the opposite direction of the injection port-side surfaces 150P (in the Y direction in FIG. 3). Consequently, in FIG. 3, the channels 16b extend along the lengthwise direction of the one surface 15a. Bottom surfaces of the channels 16b are configured by the one surface 15a.

It will be noted that “the side of the sealing body 12 where the injection ports P are formed” means the side where the injection ports P are formed when the electrode stack 11 is viewed from the stacking direction.

The plural divided regions 16a are spaced apart from each other in the widthwise direction of the one surface 15a. In the present embodiment, the positive electrodes 16 are each divided into six divided regions 16a by five channels 16b. The plural divided regions 16a have rectangular shapes whose lengthwise direction coincides with the lengthwise direction of the one surface 15a and whose widthwise direction coincides with the widthwise direction of the one surface 15a.

The plural channels 16b have, for example, mutually equal shapes. In FIG. 3, the shapes of the channels 16b (the shapes of the channels 16b in a cross-section orthogonal to the direction in which the channels 16b extend (the Y direction in FIG. 3)) are rectangular. It will be noted that the shapes of the channels 16b are not particularly limited and, for example, may be square, rectangular, triangular, or trapezoidal. In FIG. 3, the shapes of the channels 16b in the direction in which the channels 16b extend (the shapes of the channels 16b when the channels 16b are viewed in a top view) are linear. It will be noted that the shapes of the channels 16b in the direction in which the channels 16b extend are also not particularly limited and, for example, may be wavy, zigzagging, or grid-like.

Around the plural divided regions 16a on the one surface 15a of the metal plate 15, an uncoated region 150 where the positive electrode 16 is not formed is provided. The uncoated region 150 includes an uncoated region 150A provided in the region that faces the injection port-side surface 150P, an uncoated region 150B provided on the opposite side of the uncoated region 150A across the plural divided regions 16a, and uncoated regions 150C provided between the uncoated region 150A and the uncoated region 150B on the outer sides of the plural divided regions 16a. It will be noted that the internal space V is formed by the channels 16b and the uncoated region 150.

Although the drawings do not show this, the negative electrodes 17 also each include plural divided regions divided by channels in the same way as the positive electrodes 16. The channels in the negative electrodes 17 are provided so as to coincide with the channels 16b in the positive electrode 16 as viewed from the stacking direction D (see FIG. 2). Furthermore, uncoated regions are also provided around the negative electrodes 17 divided into the plural divided regions.

When injecting the electrolyte solution into the internal spaces V, vacant spaces comprising combinations of the channels in the positive electrode 16 and the channels in the negative electrode 17 function as flow paths for the electrolyte solution in the same way as vacant spaces between the uncoated regions 150 of the one surfaces 15a and the uncoated regions of the other surfaces 15b.

In the uncoated regions 150A provided in the regions that face the injection port-side surfaces 150P, a cross-sectional area [a] of the uncoated regions 150A (a cross-sectional area in a cross-section orthogonal to the direction in which the injection port-side surfaces 150 P extend (the X direction in FIG. 3)) is larger than a cross-sectional area [d] of the channels 16b (a cross-sectional area in a cross-section orthogonal to the direction in which the channels 16b extend (the Y direction in FIG. 3)).

Here, conventional batteries will be described. In conventional batteries, reducing the volume of the uncoated regions where the active material layers are not formed on the current collectors had been considered from the standpoint of improving the battery capacity. However, it has sometimes been difficult for the electrolyte solution to permeate the channels that are provided between the plural active material layers to allow the electrolyte solution to permeate. It is thought that this is because reducing the volume of the uncoated regions makes it difficult for the electrolyte solution to permeate the regions of the internal spaces that the electrolyte solution initially permeates from the injection ports, or in other words the regions of the uncoated regions that face the side of the sealing body where the injection ports are formed. When it becomes difficult for the electrolyte solution to permeate the regions of the uncoated regions that face the side of the sealing body where the injection ports are formed, permeation of the electrolyte solution into the channels that are ahead in the traveling direction of the electrolyte solution also becomes slow and, as a result, it takes time for the electrolyte solution to spread through the entireties of the internal spaces. Furthermore, by narrowing the regions of the uncoated regions that face the side of the sealing body where the injection ports are formed, the amount of the electrolyte solution that can be in that region also becomes smaller. For that reason, it becomes difficult for the electrolyte solution to spread through the channels that are ahead of those regions in the traveling direction of the electrolyte solution and, as a result, it takes time for the electrolyte solution to spread through the entireties of the internal spaces.

In contrast, in the embodiment of the present disclosure, the cross-sectional area of the uncoated regions 150A provided in the regions that face the injection port-side surfaces 150P is set larger than it is in conventional batteries, and the cross-sectional area [a] of the uncoated regions 150A is larger than the cross-sectional area [d] of the channels 16b. For that reason, the electrolyte solution more easily permeates the uncoated regions 150A, which are regions of the internal spaces that the electrolyte solution initially permeates from the injection ports.

Furthermore, because the volume of the uncoated regions 150A is larger, the amount of the electrolyte solution that can be in the uncoated regions 150A also becomes greater. For that reason, the electrolyte solution more easily spreads through the channels 16b that are ahead of the uncoated regions 150A in the traveling direction of the electrolyte solution, and the electrolyte solution more easily spreads through the entireties of the internal spaces V. As a result, the amount of time it takes for the electrolyte solution to completely permeate the whole electrode stack 11 in the manufacture of the battery is shortened. Furthermore, the occurrence of the defect that the electrolyte solution does not completely spread through the entireties of the active material layers after completion of the injection of the electrolyte solution is also inhibited.

The ratio ([d]/[a]) of the cross-sectional area [d] of the channels 16b to the cross-sectional area [a] of the uncoated regions 150A is preferably 0.1 to 0.9, more preferably 0.2 to 0.8, and even more preferably 0.2 to 0.5. When [d]/[a] is equal to or greater than the above lower limit and equal to or less than the above upper limit, the electrolyte solution more easily spreads through the entireties of the internal spaces V during injection of the electrolyte solution.

The cross-sectional area [d] of the channels 16b is preferably 0.4 mm² to 2.0 mm² and more preferably 0.5 mm² to 1.0 mm². When the cross-sectional area [d] is equal to or greater than the above lower limit, the electrolyte solution spreads more easily through the entireties of the internal spaces V during injection of the electrolyte solution. It is preferred that the cross-sectional area [d] be equal to or less than the above upper limit due to the ease of improving the battery capacity.

The cross-sectional area [a] of the uncoated regions 150A is preferably 0.4 mm² to 4.0 mm² and more preferably 1.0 mm² to 3.0 mm². When the cross-sectional area [a] is equal to or greater than the above lower limit, the electrolyte solution spreads more easily through the entireties of the internal spaces V during injection of the electrolyte solution. It is preferred that the cross-sectional area [a] be equal to or less than the above upper limit due to the ease of improving the battery capacity.

It will be noted that examples of methods of increasing the cross-sectional area [a] of the uncoated regions 150A include widening a width a of the uncoated regions 150A. Examples of methods of reducing the cross-sectional area [d] of the channels 16b include narrowing a width d of the channels 16d.

The “cross-sectional area [a], in a cross-section orthogonal to the direction in which the injection port-side surfaces extend, of regions of the uncoated regions that face the injection port-side surfaces” is the area of vacant spaces derived from the “side of the uncoated regions contiguous with the injection ports” in a cross-section obtained when the regions including the side of the uncoated regions contiguous with the injection ports are cut in a direction orthogonal to that side. Furthermore, the “cross-sectional area [d] of the channels in a cross-section orthogonal to the direction in which the channels extend” is the area of vacant spaces “derived from one arbitrary channel” in a cross-section obtained when the electrode stack is cut in a direction orthogonal to the direction in which the channels extend.

As for the measurement of the cross-sectional area [a] of the uncoated regions 150A, the cross-sectional area of the uncoated regions 150A in a cross-section orthogonal to the direction in which the injection port-side surfaces 150P extend (the X direction in FIG. 3) in the electrode stack is measured in five arbitrary cross-sections, and the arithmetic mean value of the measurements is used for the cross-sectional area [a]. Here, the cross-sectional area of the uncoated regions 150A is a value calculated by equation (1) below.

cross-sectional area (mm²) of uncoated regions 150A=length (mm) of a in FIG. 3×thickness (mm) of divided regions 16a Equation (1):

As for the measurement of the cross-sectional area [d] of the channels 16b, the cross-sectional area of the channels 16b in a cross-section orthogonal to the direction in which the channels 16b extend (the Y direction in FIG. 3) in the electrode body is measured in five arbitrary cross-sections, and the arithmetic mean value of the measurements is used for the cross-sectional area [d]. Here, the cross-sectional area of the channels 16b is a value calculated by equation (2) below.

cross-sectional area (mm²) of channels 16b=length (mm) of d in FIG. 3×thickness (mm) of divided regions 16a Equation (2):

It will be noted that description of a and d in FIG. 3 is as follows.
a: width (unit: mm) of uncoated regions 150A provided in regions that face injection port-side surfaces 150P
d: width (unit: mm) of channels 16b

In the above embodiment, an aspect was described where the active material layers of both the positive electrodes 16 and the negative electrodes 17 have channels. However, the embodiment is not limited to this, and just the positive electrode active material layers or just the negative electrode active material layers may have channels. It will be noted that from the standpoint of inhibiting lithium precipitation, it is preferred that the channels be formed just in the positive electrode active material layers.

The dimensions of the electrode stack in the battery pertaining to the embodiment of the present disclosure are not particularly limited, and the area of the electrode stack when viewed from the stacking direction of the electrode stack can, for example, be 0.5 m² or more. Furthermore, the upper limit of the area of the electrode stack can be 4.0 m² or less.

It will be noted that the configurations of the present disclosure are not limited to the above embodiment, and configurations can be changed as appropriate as long as they can solve the problem of the disclosure.

Next, advantageous effects of the battery pertaining to the embodiment of the present disclosure were confirmed by a simulation experiment.

### Examples 1 to 3, Comparative Example 1

A simulation (CEA) was performed regarding electrode stacks having the configurations shown in FIG. 3, having active material layers on the one surfaces of the metal plates serving as current collectors, having divided regions where the active material layers are divided by channels, and having uncoated regions around the active material layers where the active material layers are not provided. The shapes of the cross-sections of the channels and the uncoated regions were rectangular. However, the number of the channels was 14.

Table 1 shows the widths and the cross-sectional areas of channels (the channels 16b in FIG. 3), uncoated regions A (the uncoated region 150A in FIG. 3) provided in the regions that face the side of the sealing body where the injection ports are formed, uncoated regions B (the uncoated region 150B in FIG. 3) provided on the opposite side of the uncoated regions A across the divided regions of the active material layers, and uncoated regions C (the uncoated region 150C in FIG. 3) provided between the uncoated regions A and the uncoated regions B on the outer sides of the divided regions of the active material layers in the internal regions sealed by the sealing body.

In the simulation experiment, the amount of time (permeation time) it took for the electrolyte solution to completely permeate the whole electrode stack was calculated. The results are shown in Table 1.

TABLE 1

| | Channels | | Uncoated Region A | | | | |
|---|---|---|---|---|---|---|---|
| | | Cross- | | Cross- | Uncoated | Uncoated | |
| | | sectional | | sectional | Region B | Region C | Results |
| | Width | Area | Width | Area | Width | Width | Permeation |
| | mm | mm² | mm | mm² | mm | mm | Time |
| Example 1 | 2 | 0.736 | 3 | 1.104 | 1 | 1 | 7 hours 46 |
| | | | | | | | minutes |
| Example 2 | | | 5 | 1.84 | | | 7 hours 05 |
| | | | | | | | minutes |
| Example 3 | | | 7 | 2.576 | | | 6 hours 55 |
| | | | | | | | minutes |
| Comparative | | | 1 | 0.368 | | | 16 hours |
| Example 1 | | | | | | | |

As shown in Table 1, it will be understood that in Examples 1 to 3, which satisfy the requirement that the cross-sectional area [a] of the uncoated regions A is larger than the cross-sectional area [d] of the channels, the amount of time it takes for the electrolyte solution to completely permeate the whole electrode stack can be shorted compared to Comparative Example 1, which does not satisfy the requirement. From this, it will be understood that in Examples 1 to 3, batteries were obtained in which the ability of the electrolyte solution to be impregnated into the active material layers was improved.

What is claimed is:

1. A battery comprising:
an electrode stack comprising a stack of electrodes, each including a current collector and an active material layer that is provided on one or both surfaces of the current collector and divided into plural regions with channels in between;
a sealing body that forms internal spaces holding an electrolyte solution between the current collectors that are adjacent and seals the internal spaces; and
injection ports that are formed in the sealing body and communicate the internal spaces with the outside,
wherein
the internal spaces are formed by the channels and uncoated regions around the active material layers where the active material layers are not provided,
internal regions sealed by the sealing body have a polygonal shape when viewed from a stacking direction of the electrode stack, and
when surfaces, on the internal space side, of the side of the sealing body where the injection ports are formed are called injection port-side surfaces,
the channels extend between the divided regions of the active material layers from the side where the injection port-side surfaces are in the opposite direction of the injection port-side surfaces, and
a cross-sectional area [a], in a cross-section orthogonal to the direction in which the injection port-side surfaces extend, of regions of the uncoated regions that face the injection port-side surfaces is larger than a cross-sectional area [d] of the channels in a cross-section orthogonal to the direction in which the channels extend.

2. The battery of claim 1, wherein
the internal regions sealed by the sealing body have a quadrilateral shape when viewed from the stacking direction of the electrode stack, and
the battery has the injection ports only in a region of the sealing body that faces one side of the quadrilateral shape.

3. The battery of claim 1, wherein the ratio ([d]/[a]) of the cross-sectional area [d] of the channels to the cross-sectional area [a] of the uncoated regions is 0.1 to 0.9.

4. The battery of claim 1, wherein the cross-sectional area [d] of the channels is 0.4 mm² to 2.0 mm².

5. The battery of claim 1, wherein the area of the electrode stack when viewed from the stacking direction of the electrode stack is 0.5 m² or more.
